(19) United States
(12) Patent Application Publication
(10) Pub. No.: US 2006/0225128 A1
(43) Pub. Date: Oct. 5, 2006

(54) Measures for enhancing security in communication systems

(75) Inventors: Mikko Aittola, Vammala (FI); Lauri Lahtinen, Espoo (FI); Kalle Tammi, Nokia (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/155,765

(22) Filed: Jun. 20, 2005

(30) Foreign Application Priority Data
Apr. 4, 2005 (EP) 05 007 942.5

(51) Int. Cl. H04L 9/32

(52) U.S. Cl. 726/3

(57) ABSTRACT

A method, communication device, intermediary device, system, and computer program product for providing security of operations on a connection between a first peer entity and a second peer entity in a communication system, the peer entities each having an identity and a transport address, wherein the first peer entity requests an operation from the second peer entity using an identity and the second peer entity checks the permission of the first peer entity to be granted the requested operation using said identity by means of a pre-configured permissions list, said method comprising a step of validating the identity used by the first peer entity at the second peer entity, wherein the step of validating is performed prior to checking of the permission.

### FIELD OF THE INVENTION

The present invention relates to an enhancement of security in communication systems. In particular, the present invention relates to a method, communication device, intermediary device, system, and computer program product for providing security of operations on a connection between two peer entities in a communication system such as a 3GPP communication system.

### BACKGROUND OF THE INVENTION

In recent years, communication technology has widely spread in terms of number of users and amount of use of the telecommunication services by the users. This also led to an increase in the number of different technologies and technological concepts in use.

One aspect resides in a heterogeneity of networks, technologies and services within an overall communication system framework. Examples of such networks may e.g. include GSM (Global System for Mobile Communications), GPRS (General Packet Radio Service), UMTS (Universal Mobile Telecommunication Service). In such communication arrangements, a plurality of service providers basically provide for communication or information services for the users registered with him. Today, however, there exist many security relevant and/or user-related services which makes the provision of security aspects such as authentication and authorization mandatory in communication systems. For example, many future Internet (IP) services or mobile communication services will also require such functions. If a user, for example, wants to use a security-relevant service of another service provider, the user has to authenticate and/or authorize himself.

Conventionally, a specialized network for performing such functions as described above is built up “on top of” the communication network, and is often referred to as AAA (authorization, authentication and accounting) network. The thus realized functions like system access and database look-ups can take place in specific and separate AAA nodes, but in practice, these nodes are often implemented within the nodes of the underlying communication system, which has the advantage of a joint use of hardware and thus reduced costs.

The use of AAA techniques provides as benefits an increased flexibility and control, scalability, and the usage of standardized authentication methods. However, specialized security and routing protocols are also needed for performing AAA functions properly and for routing respective messages related to AAA functions. Examples for such standardized AAA protocols, which are known to a skilled person, include RADIUS (Remote Access Dial-In User Services) which is standardized by the IETF (Internet Engineering Task Force), TACACS+ (Terminal Access Controller Access System), and Kerberos. These protocols are used for dial-in and terminal server access to the AAA network mainly from the outside. As an example, a user roaming in a domain of another service provider than his own provider has to authenticate himself within this domain. Therefore, he sends a request, possibly together with or like a password, to an AAA node within his home domain for providing him with the required services.

Another protocol of this type is an AAA protocol called Diameter. Diameter is defined by the IETF. Different kinds of access technologies and applications can utilize the capability of the Diameter Base Protocol, and send/receive their specific AAA messages.

The Diameter base protocol provides a session-oriented and a non-session-oriented framework for the AAA functionality and routing of AAA messages. In many aspects, Diameter protocol is similar to the nowadays commonly used challenge-response-type RADIUS protocol. The terminology defined by IETF RFC3588 (Diameter Base Protocol) in the version of September 2003 will form the basis for the terms used in the further description.

In this context, it is to be noted that in the present application a connection is to be understood as a transport level link between two peer entities for exchanging respective messages (e.g. Diameter messages). A peer entity is to be understood as a network node including a terminal device, to which a given node, server, or communication device (also referred to as peer entity) has a direct transport connection.

The Diameter Base Protocol, hereinafter merely referred to as Diameter, is used for example in an 3GPP IP Multimedia Subsystem (IMS), and in particular on Cx, Dx, Sh, Th, Ro, and Rf interfaces defined therein.

For providing security features, and in particular for providing network and transport level security features, Diameter basically relies on IPSec (Internet Protocol Security protocol) or TLS (Transport Layer Security protocol), both of which are security protocols well-known to a person skilled in the art. Thereby, methods for authenticating the communicating entities of a Diameter connection, hereinafter referred to as Diameter peer entities, are provided. Thus, a usage of such methods ensures that only trusted, i.e. authenticated, peer entities are able to exchange messages. More details on Diameter security issues can also be found in RFC3588 mentioned above.

Diameter applications relating to the Sh reference point (as specified e.g. in 3GPP specification TS 29.328, V6.4.0 of December 2004) feature a so-called AS permissions list which is used to control operations over the Sh reference point. Each application server AS has its own set of permissions, and is identified by its Diameter identity. (This Diameter identity is included in the Origin-Host AVP being a mandatory part of each Diameter message.) In the AS permissions list, the association between the single application servers present in the system and the specific operations permitted to each of them is defined. The respective permissions apply to all users served by the home subscriber server, thus they are not user-specific.

That is, an application server may request to read (or pull) information stored in the home subscriber server HSS, to write (or update) such information, or to be notified of changes to specific information. The home subscriber server then checks the permission of the application server AS to be granted the requested operation using the identity used by the requesting application server by means of the pre-configured AS permissions list. In case the requesting AS is permitted to use the requested operation, it is carried out, and otherwise an error result is returned from the HSS to the requesting AS.

However, it is possible that such a trusted peer entity fakes its identity (in this case, its Diameter identity). This can happen either right from the beginning of a Diameter connection establishment or only for selected Diameter messages during an ongoing connection. Especially the latter kind of security attack by faking one's identity would be very difficult to detect with conventional security mechanisms as hitherto used.

As an example for illustrating the problems inherent to the security mechanisms according to the prior art, there is considered a connection between an application server AS (an SIP application server based on the session initiation protocol, for example) and a home subscriber server HSS within the framework of the 3GPP IMS subsystem. The interface between these peer entities is known as Sh reference point (cf. 3GPP TS 29.328, V6.4.0).

If a malicious application server fakes its Diameter identity (i.e. it poses as another application server by using the identity of this other AS), it is able to get permissions to store, modify, and/or read data, for which itself is not authorized to (but the other application server as which the malicious application sever poses is).

Such a scenario is illustrated in FIG. 1 which shows a signaling diagram of a security method over the Sh interface according to the prior art.

In step 1 according to FIG. 1, the application server denoted by AS1 sends a request REQ to the home subscriber server denoted by HSS. As parameters the request contains “AS1” as the (true) identity of the application server, and “P” as an indication of the requested operation, i.e. pulling of data from HSS. Upon receipt of the request, the home subscriber server checks by use of the AS permissions list whether the application server AS1 is allowed to be granted an operation of pulling of data (step 2). According to the AS permissions list, AS1 is permitted to use operations U (i.e. updating) and N (i.e. notifying), but not operation P as requested. Thus, the enquiry of the permissions list yields a negative result (“NOK”), and the home subscriber server HSS returns a negative response RESP to the requesting application server in step 3. That is, it is denied by the HSS that AS1 is permitted to use operation P.

The double line on the side of AS1 (between steps 3 and 4) indicates that the application server in question from there on fakes its own identity. Namely, AS1 in the following poses as AS2, wherein it is not relevant for the present application how the application server obtains the necessary information to do so (i.e. identity of AS2). In step 4, application server AS1 again requests operation P, but now pretending to be AS2. In step 5, the home subscriber system again carries out an enquiry by means of the AS permissions list. It yields the result that application server AS2 is permitted to use any one of operations P, U, and N. Since the home subscriber server is not aware of the identity AS2 being faked by AS1, and does not have any means to detect such a faking, it return a positive response (“OK”) to the requesting (malicious) application server AS1, which is thereby permitted to read data from the HSS.

It is to be noted that the response messages are addressed to the transport address used by application server AS1 when sending the respective request, and not to the Diameter identity used. Thus, although the Diameter identity is faked (which leads to a wrong permission enquiry), the message indeed arrives at (the transport address of) AS1. This is due to the distributed functionalities of different layers (in the present case, of the network layer and the transport layer) according to the Open Systems Interconnection (OSI) network model, and Diameter base protocol message routing functionality.

Hence, as can be gathered from the example illustrated in FIG. 1 and described above, there is no means according to the prior art to avoid and/or detect a Diameter peer entity performing a security attack by faking its identity.

The U.S. patent application Ser. No. 10/940,981 (which was filed by the same applicant as the present application and has not yet been published at the filing date hereof) is directed to a somewhat similar problem. There is presented a method for providing security of a session between a client of a domain of a network and a service node of said network, which network consists of a plurality of domains. In U.S. Ser. No. 10/940,981 a realm-based security mechanism is presented which is based on routing information contained in messages. However, it is to be noted that the thus presented solution is particularly targeted on domain-based networks and the specific security problems inherent in such networks.

Thus, a general solution to the above problems and drawbacks is still needed for providing more secure connections between peer entities in a communication system such as the 3GPP IP multimedia subsystem. Summary of the invention

Consequently, it is an object of the present invention to remove the above problems and drawbacks inherent to the prior art and to provide an accordingly improved method, apparatus, system, and computer program product.

According to a first aspect of the invention, this object is for example achieved by a method for providing security of operations on a connection between a first peer entity and a second peer entity in a communication system, the peer entities each having an identity and a transport address, wherein the first peer entity requests an operation from the second peer entity using an identity and the second peer entity checks the permission of the first peer entity to be granted the requested operation using said identity by means of a pre-configured permissions list, said method comprising a step of validating the identity used by the first peer entity at the second peer entity, wherein the step of validating is performed prior to checking of the permission.

According to further advantageous developments at least one of the following applies:

the step of validating the identity used by the first peer entity comprises a step of determining whether said identity is a valid identity according to a security association between the first peer entity and the second peer entity, wherein a negative validation result is yielded, if it is determined that said identity is not valid;

the step of determining is performed on the basis of a security configuration table being maintained at the second peer entity, said security configuration table comprising valid pairs of identities and at least one parameter of said security association;

the at least one parameter of said security association comprises the transport address of the first peer entity;

the step of validating the identity used by the first peer entity comprises a step of detecting whether said identity has changed during the ongoing connection, wherein a negative validation result is yielded, if it is detected that said identity has changed;

the method further comprises a step of storing an identity originally used by the first peer entity in the ongoing connection at the second peer entity;

the method further comprises a step of transmitting a response of denial of the requested operation from the second peer entity to the first peer entity, if the step of validating yields a negative validation result;

the response indicates a security problem to the first peer entity;

an intermediary device is located on the connection in-between the first peer entity and the second peer entity, the method further comprising a step of validating the identity used by the first peer entity at the intermediary device;

the step of validating at the intermediary device comprises a step of determining whether said identity is a valid identity according to a security association between the first peer entity and the intermediary device, wherein a negative validation result is yielded, if it is determined that said identity is not valid;

the step of validating at the intermediary device comprises a step of detecting whether said identity has changed during the ongoing connection, wherein a negative validation result is yielded, if it is detected that said identity has changed;

the method further comprises a step of transmitting a response of denial of the requested operation from the intermediary device to the first peer entity, if the step of validating at the intermediary device yields a negative validation result;

the method further comprises a step of forwarding the request from the first peer entity to the second peer entity, if the step of validating at the intermediary device yields a positive validation result;

the intermediary device is a proxy node;

the intermediary device is a relay agent;

the first peer entity is an application server;

the second peer entity is a home subscriber server;

the method is based on a protocol associated with authorization, authentication and accounting functions;

the protocol is a Diameter base protocol;

the identity used by the first peer entity is an identity in accordance with a Diameter base protocol;

the protocol is a RADIUS protocol;

the identity used by the first peer entity is an identity in accordance with a RADIUS protocol;

the transport address is based on an Internet protocol; and/or

the connection between the first peer entity and the second peer entity comprises an Sh reference point in accordance with 3GPP specifications.

According to a second aspect of the invention, this object is for example achieved by a communication device configured for use in a method of providing security of operations on a connection between a first peer entity and the communication device as a second peer entity in a communication system, the peer entities each having an identity and a transport address, wherein the first peer entity requests an operation from the second peer entity using an identity, said communication device comprising receiver devices configured to receive a request from the first peer entity; checker devices configured to check the permission of the first peer entity to be granted the requested operation using said identity by means of a pre-configured permissions list; first memory devices configured to store the pre-configured permissions list; and validator devices configured to validate the identity used by the first peer entity, wherein the validator devices are further configured to perform validating prior to the checker devices performing checking of the permission.

According to further advantageous developments at least one of the following applies:

the validator devices comprise determinator devices configured to determine whether the identity used by the first peer entity is a valid identity according to a security association between the first peer entity and the second peer entity, wherein the determinator devices are further configured to yield a negative validation result, if it is determined that said identity is not valid;

the determinator devices are further configured to perform validating on the basis of a security configuration table being maintained at the second peer entity, said security configuration table comprising valid pairs of identities and at least one parameter of said security association;

the communication device further comprises second memory devices configured to store said security configuration table;

the at least one parameter of said security association comprises the transport address of the first peer entity;

the validator devices comprise detector devices configured to detect whether the identity used by the first peer entity has changed during the ongoing connection, wherein the detector devices are further configured to yield a negative validation result, if it is detected that said identity has changed;

the communication device further comprises third memory devices configured to store an identity originally used by the first peer entity in the ongoing connection;

the communication device further comprises transmitter devices configured to transmit a response of denial of the requested operation to the first peer entity, if the validator devices yield a negative validation result;

the response indicates a security problem to the first peer entity;

the communication device is a home subscriber server;

the communication device operates on the basis of a protocol associated with authorization, authentication and accounting functions;

the identity used by the first peer entity is an identity in accordance with a Diameter base protocol;

the identity used by the first peer entity is an identity in accordance with a RADIUS protocol;

the transport address is based on an Internet protocol; and/or

the connection between the first peer entity and the second peer entity comprises an Sh reference point in accordance with 3GPP specifications.

According to a third aspect of the invention, this object is for example achieved by an intermediary device configured for use in a method of providing security of operations on a connection between a first peer entity and a second peer entity in a communication system, wherein the intermediary device is located on the connection in-between the peer entities, the peer entities each having an identity and a transport address, wherein the first peer entity requests an operation from the second peer entity using an identity, said intermediary device comprising receiver devices configured to receive a request from the first peer entity and a response from the second peer entity; and validator devices configured to validate the identity used by the first peer entity.

According to further advantageous developments at least one of the following applies:

the validator devices comprise determinator devices configured to determine whether the identity used by the first peer entity is a valid identity according to a security association between the first peer entity and the intermediary device, wherein the determinator devices are further configured to yield a negative validation result, if it is determined that said identity is not valid;

the intermediary device further comprises first memory devices configured to store a security configuration table;

the validator devices comprise detector devices configured to detect whether the identity used by the first peer entity has changed during the ongoing connection, wherein the detector devices are further configured to yield a negative validation result, if it is detected that said identity has changed;

the intermediary device further comprises second memory devices configured to store an identity originally used by the first peer entity in the ongoing connection;

the intermediary device, further comprises transmitter devices configured to transmit a request from the first peer entity to the second peer entity, if the validator devices of the intermediary device yield a positive validation result; and/or

the intermediary device further comprises transmitter devices configured to transmit a response of denial to the first peer entity, if the validator devices of the intermediary device yield a negative validation result;

the intermediary device operates on the basis of a protocol associated with authorization, authentication and accounting functions;

the intermediary device is a Diameter proxy node; and/or

the intermediary device is a Diameter relay agent.

According to a fourth aspect of the invention, this object is for example achieved by a system for providing security of operations on a connection between a first peer entity and a second peer entities in a communication system, the peer entities each having an identity and a transport address, wherein the first peer entity requests an operation from the second peer entity using an identity and the second peer entity checks the permission of the first peer entity to be granted the requested operation using said identity by means of a pre-configured permissions list, said system comprising:

at least one first peer entity comprising:

transmitter devices configured to transmit a request for an operation to the second peer entity; and

at least one second peer entity comprising:

receiver devices configured to receive a request from the first peer entity;

checker devices configured to check the permission of the first peer entity to be granted the requested operation using said identity by means of a pre-configured permissions list;

first memory devices configured to store the pre-configured permissions list; and

validator devices configured to validate the identity used by the first peer entity,

wherein the validator devices are further configured to perform validating prior to the checker devices performing checking of the permission.

According to further advantageous developments at least one of the following applies:

the at least one second peer entity is configured according to the second aspect of the present invention;

the system further comprises at least one intermediary device being located on the connection in-between the peer entities, said intermediary device comprising receiver devices configured to receive a request from the first peer entity and a response from the second peer entity; and validator devices configured to validate the identity used by the first peer entity;

the at least one intermediary device is configured according to the third aspect of the present invention;

the at least one first peer entity is an application server;

the at least one second peer entity is a home subscriber server; and/or

the connection between the first peer entity and the second peer entity comprises an Sh reference point in accordance with 3GPP specifications.

According to a fifth aspect of the invention, this object is for example achieved by a computer program product being loadable into a memory of a digital processing means and comprising software code portions for performing the steps of the method according to the first aspect of the present invention when said product is run on said digital processing means.

It is an advantage of the present invention that an improvement of Diameter protocol security issues is provided in general.

With the embodiments of the present invention, it is advantageously possible to utilize permissions information available at a peer entity in a secure way. This particularly applies to AS permissions lists related to the Sh interface in accordance with 3GPP specifications.

It is another advantage of the embodiments of the present invention that the improvement of security is achieved with only little additional processing and without any structural changes to existing protocols and/or procedures.

### BRIEF DESCRIPTION OF THE DRAWINGS

In the following, the present invention will be described in greater detail with reference to the accompanying drawings, in which

FIG. 1 shows a signaling diagram of a security method over the Sh interface according to the prior art,

FIG. 2 shows an example of a signaling diagram of a security method according to one embodiment of the present invention,

FIG. 3 shows an example of a signaling diagram of a security method according to another embodiment of the present invention,

FIG. 4 shows an example of a signaling diagram of a security method according to still another embodiment of the present invention,

FIG. 5 shows an example of a block diagram of a home subscriber server according an embodiment of the present invention, and

FIG. 6 shows an example of a block diagram of an intermediary device according to another embodiment of the present invention.

### DETAILED DESCRIPTION OF EMBODIMENTS OF THE PRESENT INVENTION

The present invention is described hereinafter with reference to particular non-limiting examples. A person skilled in the art will appreciate that the invention is not limited to these examples, and may be more broadly applied.

In particular, it is to be noted that although Diameter is used as an example protocol herein on which the procedures are based and although the Sh interface in accordance with 3GPP specifications is used as an exemplary reference point, the present invention is not limited to these specific conditions. Rather, the present invention is applicable to any communication system and any scenario exhibiting similar conditions. Although not mentioned explicitly each time, the embodiments of the present invention are also suited for being applicable, for example, with any protocol associated with authorization, authentication and accounting (AAA) functions, one example of which is the RADIUS protocol mentioned above.

As such, the description of the embodiments given herein specifically refers to terminology which is directly related to Diameter and the 3GPP IMS subsystem. Such terminology is also only used in the context of the presented examples, and does not limit the invention in any way.

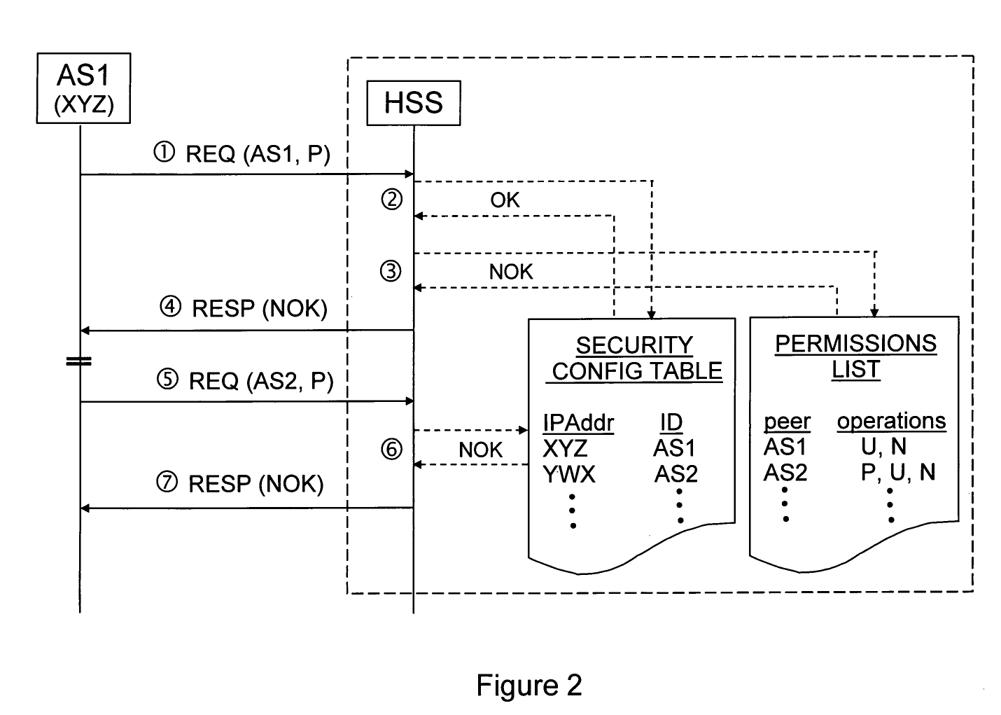

FIG. 2 shows a signaling diagram of a security method according to one embodiment of the present invention.

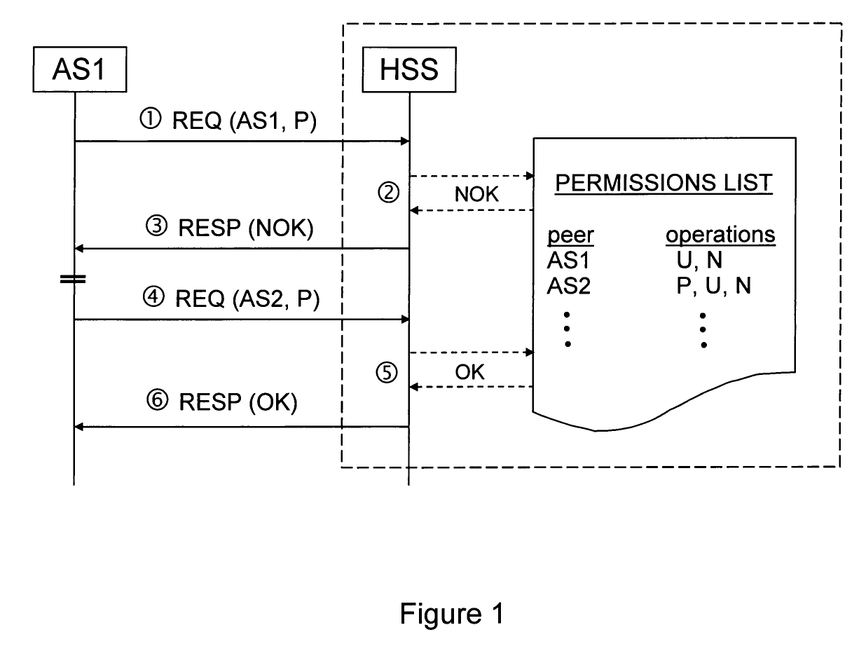

The scenario illustrated in FIG. 2 is essentially similar to that of FIG. 1 described above. That is, a security method over the Sh interface between an application server AS1 and a home subscriber server HSS is shown by way of example for illustrating one embodiment of the present invention. In the present example, application server AS1 uses transport address XYZ which stands for example for an Internet Protocol (IP) address in the form of xxx.yyy.zzz where x, z, and z represent integers, respectively.

In step 1, the application server AS1 as a first peer entity requests an operation P (pull) from the home subscriber server HSS as a second peer entity using its own identity, i.e. AS1 sends a request in the form of REQ(AS1,P) to the HSS.

According to the present embodiment of the invention, there is configured to the second peer entity HSS a table defining the Diameter identity or identities ID that a transport address IPAddr is allowed to use. In FIG. 2, this table is depicted as a security config table. The configuration of the allowed Diameter identities for IP addresses is exemplarily implemented as a part of a peer table previously defined in association with a Diameter peer entity. Thus, it can be considered that the security config table represents security associations between respective peer entities, and comprises respective pairs of identities and transport addresses representing at least one parameter of the security associations. Although in FIG. 2, for the sake of simplicity the correspondence between transport addresses and identities is depicted as an one-to-one correspondence, it should be noted that one Diameter identity can also resolve to several IP addresses. Further, it is also useful that it is able to define more than one valid Diameter identity for a given IP address, in particular in a case of multiple Diameter peers running on the same server.

The second peer entity then checks for each received Diameter message that the Diameter identity in the Origin-Host AVP (AVP: attribute value pair) is allowed for the IP address from which the message has been sent. Thereby, it is to be noted that the value of the IP address itself can be trusted because, as mentioned above, IPSec or TLS security is used for providing security features including data origin authentication. Stated in other words, the home subscriber server HSS validates the identity used by the first peer entity. In FIG. 2, the validation is performed in step 2 by determining whether the identity used by the application server AS1, i.e. AS1, is a valid identity by means of the pre-configured security config table. In step 2, a positive validation result is yielded by the enquiry of said table since the IP address XYZ used by the application server AS1 and the identity currently used are validly associated.

Thereafter, the home subscriber server HSS performs an enquiry of the AS permissions list as was described in connection with the prior art, and thereupon returns a negative response to the application server AS1 because of having no permission to use operation P as requested.

At this point indicated by the double line on the side of AS1 (between steps 4 and 5) the intermediate result is effectively the same as according to the prior art, i.e. it is denied that AS1 uses operation P.

In step 5, the application server in question again fakes its identity, i.e. poses as application server AS2, and again requests operation P but now unwarrantedly using the identity AS2.

During validation of the identity used by the first peer entity AS1 the second peer entity HSS again determines whether the identity used is valid, which is performed using the security config table. But this enquiry of step 6 now yields a negative validation result since the transport address used, i.e. XYZ, which is not and can not be faked by AS1 because of e.g. IPSec usage as described previously, does not match with the identity used, i.e. AS2. Hence, it is determined that the identity used by the first peer entity is not valid. Thus, a further enquiry of the AS permissions can be skipped. The HSS returns a negative validation result, i.e. a response of denial of the requested operation to the requesting application server AS1 (which is contrary to the final result according to the prior art as described in connection with FIG. 1).

In practice, the negative validation result response could be implemented by using a pre-defined result code DIAMETER_INVALID_AVP_VALUE, whereby it is indicated to the requesting application server AS1 that the problem is in the Origin-Host AVP of the Diameter message sent, i.e. the Diameter identity used has been determined to be invalid. Thereby, a security problem is indicated to the first peer entity. Alternatively, the HSS could respond by using a pre-defined result code such as DIAMETER_UNABLE_TO_COMPLY, if the second peer entity does not want to indicate to the sender of the request, i.e. to the first peer entity, that a security problem has occurred. Another alternative is to use the same result codes that are used to indicate to the application server in question that it did not have permission for the operation, e.g. DIAMETER_ERROR_USER_DATA_CANNOT_BE_READ, DIAMETER_ERROR_USER_DATA_CANNOT_BE_MODIFIED, and DIAMETER_ERROR_USER_DATA_CANNOT_BE_NOTIFIED. Although described in more detail above with reference to one embodiment, the principle of the method according to the present invention, stated in other words, lies in providing security of operations on a connection between a first peer entity and a second peer entity in a communication system, the peer entities each having an identity and a transport address, wherein the first peer entity requests an operation from the second peer entity using an identity and the second peer entity checks the permission of the first peer entity to be granted the requested operation using said identity by means of a pre-configured permissions list. This method comprises the step of validating the identity used by the first peer entity at the second peer entity, wherein the step of validating is performed prior to checking of the permission.

It is to be noted that in general the application server identity can, instead of or in addition to the transport address of the sender as one conceivable parameter, also be configured and validated against other parameters that identify a security association between home subscriber server and application server in question.

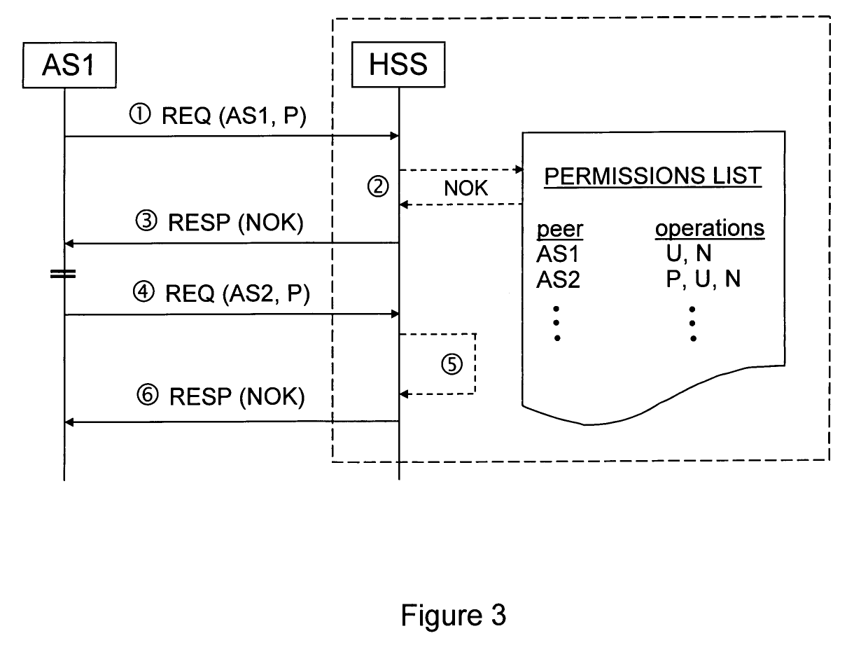

FIG. 3 shows a signaling diagram of a security method according to another embodiment of the present invention. The presented embodiment relates to a case where the security policy allows a dynamic discovery of peer entities. In such a case, it is not possible to use pre-defined configurations of allowed Diameter identities for given transport addresses (i.e. security config tables).

In principle, the scenario illustrated in FIG. 3 is similar to the ones illustrated in FIGS. 1 and 2, particularly to the one of FIG. 1 without the use of a security configuration table. Thus, the description of steps 1 to 3 is omitted by referring to the respective earlier description of the respective steps in FIG. 1.

The double line on the side of AS1 (between steps 3 and 4) again indicates that the application server AS1 in question from there on fakes its own identity. Namely, AS1 in the following poses as AS2. In step 4, application server AS1 again requests operation P pretending to be AS2. In step 5, according to the present embodiment of the invention, the home subscriber server detects whether the identity used by the first peer entity AS1 has changed during the lifetime of the ongoing Diameter connection.

In the present example case, the home subscriber server HSS detects during validating of the identity used by the first peer entity that the first peer entity has already used AS1 as its Diameter identity and now uses AS2 as its Diameter identity within the same transport connection. For this purpose, the identity which the application server AS1 originally used in the currently ongoing Diameter connection has to be stored at the second peer entity. Thus, in step 5, a negative validation result is yielded by the detection (i.e. AS2≠AS1), and the home subscriber server HSS as the second entity returns a response of denial of the requested operation to the first peer entity, i.e. the application server AS1. In practice, the response can be implemented the same way as described in connection with FIG. 2.

In short, a secure handling of AS permissions lists related to the Sh interface consequently requires that the home subscriber server is able to validate application server identity. This can be realized in that one of the above described security methods (or any equivalent modifications thereof) is implemented to the home subscriber server.

Thereby, a hop-by-hop security is provided. In order to provide an end-to-end security as well, the method of the present invention can also be used as follows.

If there are Diameter proxies (i.e. relay nodes) between the home subscriber server HSS and the application server AS (e.g. AS1), the application server identity should be validated also by the intermediary Diameter proxies, or if that is not possible, all application servers behind a respective proxy should be given equal permissions.

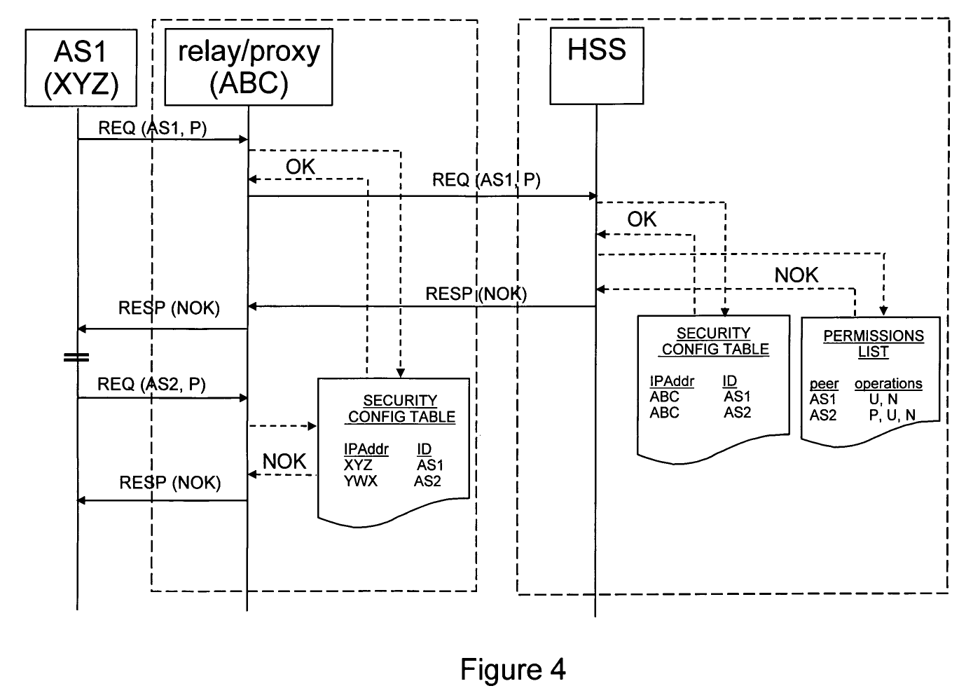

FIG. 4 shows an example of a signaling diagram of a security method according to an embodiment of the present invention in accordance with a scenario including one or more intermediary devices (hereinafter referred to as relay/proxy nodes).

In the example scenario of FIG. 4, application server AS1 uses transport address XYZ, and a relay/proxy node uses transport address ABC, both of which stand for example for an Internet Protocol (IP) address.

First, the application server AS1 as a first peer entity wishes to request an operation P (pull) from the home subscriber server HSS as a second peer entity using its own identity. In the present embodiment, application server AS1 does however not send a respective request to the home subscriber server HSS but to the intermediary device denoted by relay/proxy.

According to the present embodiment of the invention, there is configured to the intermediary device a table defining the Diameter identity or identities ID that a transport address IPAddr is allowed to use. In FIG. 4, this table is depicted as a security config table. Its configuration is similar to the security config table according to previously described embodiments.

The relay/proxy node then checks for each received Diameter message that the Diameter identity in the Origin-Host AVP (AVP: attribute value pair) is allowed for the IP address from which the message has been sent. Thereby, it is to be noted that the value of the IP address itself can be trusted because, as mentioned above, IPSec or TLS security is used for providing security features including data origin authentication. Stated in other words, the relay/proxy node validates the identity used by the first peer entity. In FIG. 4, the validation is performed by determining whether the identity used by the application server AS1, i.e. AS1, is a valid identity by means of the pre-configured security config table. In the present example, a positive validation result is yielded by the enquiry of said table since the IP address XYZ used by the application server AS1 and the identity currently used are validly associated.

Thereupon, the relay/proxy node forwards the request from application server AS1 to the home subscriber server HSS. At the home subscriber server, there are performed operations which are similar to those described in connection with FIG. 2 above. Thus, a detailed explanation of the operations at the HSS are omitted at this point.

Accordingly, the home subscriber server HSS returns a negative response to the relay/proxy node which forwards this message to the application server AS1.

At this point indicated by the double line on the side of AS1 the intermediate result is effectively the same as according to the prior art or other embodiments, i.e. it is denied that AS1 uses operation P.

In the next step, the application server in question again fakes its identity, i.e. poses as application server AS2, and again requests operation P but now unwarrantedly using the identity AS2.

During validation of the identity used by the first peer entity AS1 the relay/proxy node receiving the request again determines whether the identity used is valid, which is performed using the security config table. But this enquiry now yields a negative validation result since the transport address used, i.e. XYZ, which is not and can not be faked by AS1 because of e.g. IPSec usage as described previously, does not match with the identity used, i.e. AS2. Hence, it is determined that the identity used by the first peer entity is not valid. Thus, a forwarding of the respective request can be skipped, and the relay/proxy node returns a negative validation result, i.e. a response of denial of the requested operation to the requesting application server AS1.

Although not shown explicitly, in the present example case, the relay/proxy node as an intermediary device is also suited to detect during validating of the identity used by the first peer entity that the first peer entity has already used AS1 as its Diameter identity and now uses AS2 as its Diameter identity within the same transport connection (similar to step 5 of FIG. 3). For this purpose, the identity which the application server AS1 originally used in the currently ongoing Diameter connection has to be stored at the relay/proxy node.

According to another embodiment of the present invention, there is also provided a computer program product being loadable into a memory of a digital processing means and comprising software code portions for performing any steps of any method according to any embodiment of the present invention when said product is run on said digital processing means.

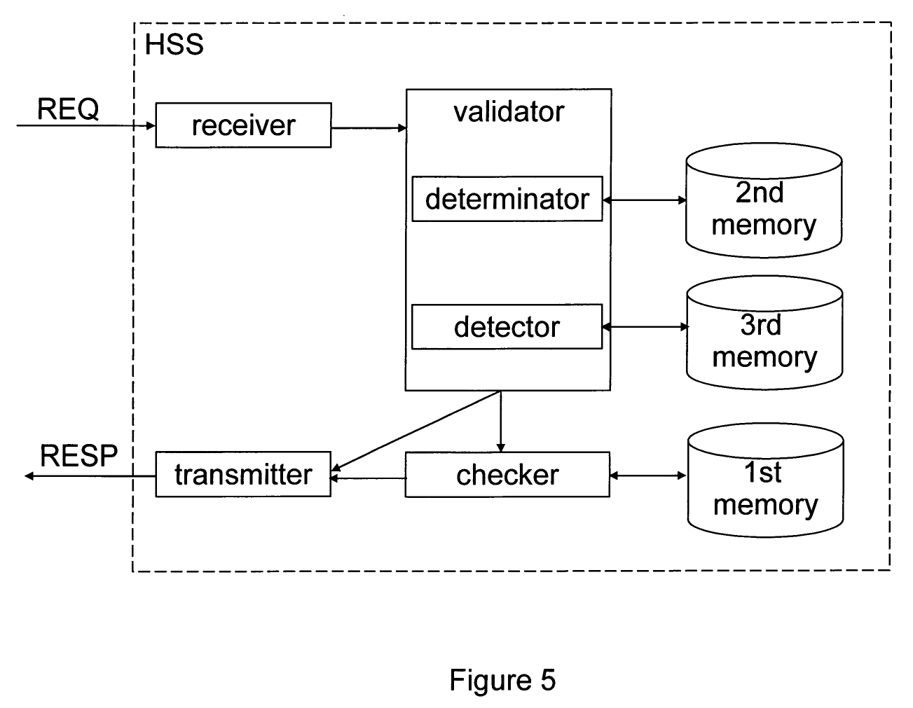

FIG. 5 shows a block diagram of a home subscriber server according an embodiment of the present invention.

The exemplary home subscriber server HSS according to FIG. 5 depicts one embodiment of a communication device of the present invention. Together with at least one first peer entity such as an application server, at least one of the illustrated HSS (as a second peer entity) constitutes a system for providing security of operations on a connection between a first peer entity and a second peer entity according to the present invention.

According to FIG. 5, the communication device (i.e. home subscriber server HSS) comprises receiver devices denoted by receiver, which are configured to receive a request REQ from a first peer entity (not shown) e.g. over a Sh interface connection, whether directly or via an intermediary node. The home subscriber server further comprises validator devices denoted by validator, which are configured to validate the identity used by the first peer entity and contained in the request received. The validator devices are further configured to perform validating prior to a checking of a permission of the first peer entity to be granted the requested operation by checker devices (“checker”) of the communication device HSS. Such a checking is only performed, if the validator devices yield a positive validation result, and otherwise a negative response RESP indicating a denial of the requested operation is sent to the requesting first peer entity by means of transmitter devices (“transmitter”) of the communication device HSS. Such a denial can be sent either directly to the requesting first peer entity or via an intermediary node. The checker devices are further configured to check the permission of the first peer entity to be granted the requested operation using said identity by means of a pre-configured permissions list being stored in first memory devices of the communication device which are configured to store the pre-configured permissions list. Thereafter, the checker devices cause the transmitter devices to send a respective response to the requesting peer entity dependent on the result of checking of the permissions.

The validator devices according to FIG. 5 comprise determinator devices (“determinator”) which are configured to determine whether the identity used by the first peer entity is a valid identity according to a security association between the first peer entity and the second peer entity. The determinator devices are further configured to yield a negative validation result, if it is determined that the identity used by the first peer entity is not valid. The determinator devices are further configured to perform validating (determining) on the basis of a security configuration table, said security configuration table comprising valid pairs of identities and at least one parameter (e.g. a transport address of the first peer entity) of said security association. For storing said security configuration table there are provided accordingly configured second memory devices.

The validator devices according to FIG. 5 also comprise detector devices which are configured to detect whether the identity used by the first peer entity has changed during the ongoing connection, wherein the detector devices are further configured to yield a negative validation result, if it is detected that the identity used by the first peer entity has changed during the ongoing connection. For storing an identity originally used by the first peer entity in the ongoing connection there are provided accordingly configured third memory devices.

It is to be noted that the communication device according to another embodiment of the present invention comprises only one of the determinator devices (together with the second memory devices) and the detector devices (together with the third memory devices).

The communication device illustrated in FIG. 5 is thus configured for use in a method of providing security of operations on a connection between a first peer entity and the communication device as a second peer entity in a communication system according to the present invention.

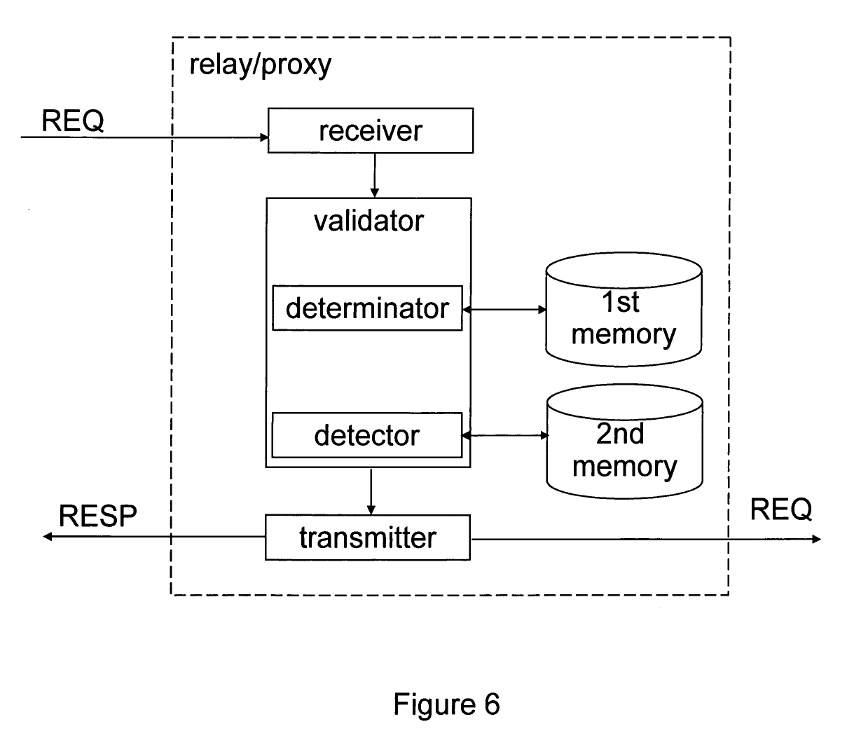

FIG. 6 shows an example of a block diagram of an intermediary device according to another embodiment of the present invention. The intermediary device illustrated in FIG. 6 is, for example, the relay/proxy node shown in FIG. 4. Thus, on the left hand side of the intermediary device denoted by “relay/proxy” is located an application server, and on the right hand side is located a home subscriber server. (The respective arrows depicted are intended to illustrate connections to the respective peer entity on the particular side.)

In general the intermediary device according to the present embodiment of the invention operates on the basis of a protocol associated with authorization, authentication and accounting functions (i.e. Diameter, RADIUS, for example) . Hence, according to a respective implementation scenario, the intermediary node is for example a Diameter proxy node or a Diameter relay agent.

According to the present embodiment illustrated in FIG. 6, the intermediary device comprises receiver devices (“receiver”) which are configured to receive a request from the application server, i.e. the first peer entity, and a response (not shown) from the home subscriber server, i.e. the second peer entity. The intermediary device further comprises validator devices (“validator) which are configured to validate the identity used by the first peer entity. It is to be noted that the validator devices of FIG. 6 are similar to the validator devices of FIG. 5, except that the associated memory devices are numbered differently. Hence, also the function of the validator devices of the intermediary device (FIG. 6) are similar to the functions of the validator devices of the home subscriber server (FIG. 5).

The intermediary device according to the present embodiment further comprises transmitter devices (“transmitter”) which are configured to forward a request from the first peer entity to the second peer entity, if the validator devices of the intermediary device yield a positive validation result. The transmitter devices are further configured to transmit a response of denial to the first peer entity, if the validator devices of the intermediary device yield a negative validation result, and to forward a response (not shown) from a home subscriber server to an application server.

The intermediary device illustrated in FIG. 6 is thus configured for use in a method of providing security of operations on a connection between a first peer entity and a second peer entity in a communication system according to the present invention.

In general, it is to be noted that the mentioned functional elements, e.g. the communication device according to the present invention, and their constituents can be implemented by any known means, either in hardware and/or software, respectively, if it is only adapted to perform the described functions of the respective parts. For example, the validator devices of the communication device can be implemented by any data processing unit, e.g. a microprocessor, being configured to validate an identity of another communication device in the way as defined by the appended claims. The mentioned parts can also be realized in individual functional blocks or by individual devices, or one or more of the mentioned parts can be realized in a single functional block or by a single device. Correspondingly, the above illustration of FIG. 5 is only for illustrative purposes and does not restrict an implementation of the present invention in any way.

Furthermore, method steps likely to be implemented as software code portions and being run using a processor at one of the peer entities are software code independent and can be specified using any known or future developed programming language such as e.g. C, C++, and Assembler. Method steps and/or devices or means likely to be implemented as hardware components at one of the peer entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. In this context, it is also to be noted that the first to third memory devices can also be realized outside the communication device of the present invention without limiting its scope. Hence, the permissions list and/or the security config list used by the HSS (cf. FIGS. 1 to 3) can also be maintained apart from the HSS itself at any other network element of the underlying network. Such and similar principles are to be considered as known to those skilled in the art.

In summary, according to the present invention and embodiments thereof, the identities (e.g. Diameter identities) that a given transport address (e.g. IP address), namely a peer entity communicating by using a given transport address, is allowed to use are configured to this peer entity (e.g. Diameter peer entity). The peer entity (e.g. Diameter peer entity) then checks for each (Diameter) message that the (Diameter) identity in the data field representing the sender's identity (e.g. Origin-Host AVP in a Diameter message) is allowed for the transport address from which the (Diameter) message has been sent.

From the above, it is obvious to those skilled in the art that currently standardized prior art access right functionalities e.g. of the Sh interface are somewhat useless without the additional security according to the present invention being added.

According to the present invention, there is provided a method, communication device, intermediary device, system, and computer program product for providing security of operations on a connection between a first peer entity and a second peer entity in a communication system, the peer entities each having an identity and a transport address, wherein the first peer entity requests an operation from the second peer entity using an identity and the second peer entity checks the permission of the first peer entity to be granted the requested operation using said identity by means of a pre-configured permissions list, said method comprising a step of validating the identity used by the first peer entity at the second peer entity, wherein the step of validating is performed prior to checking of the permission.

Even though the invention is described above with reference to the examples according to the accompanying drawings, it should be understood that the invention is not restricted thereto. Rather, it is apparent to those skilled in the art that the present invention can be modified in many ways without departing from the scope of the inventive idea as disclosed in the appended claims.

1. A method for providing security of operations on a connection between a first peer entity and a second peer entity in a communication system, the peer entities each having an identity and a transport address, wherein the first peer entity requests an operation from the second peer entity using an identity and the second peer entity checks a permission of the first peer entity to be granted the requested operation using said identity by means of a pre-configured permissions list, said method comprising a step of:
validating the identity used by the first peer entity at the second peer entity,
wherein the step of validating is performed prior to checking of the permission.

2. The method according to claim 1, wherein the step of validating the identity used by the first peer entity comprises a step of:
determining whether said identity is a valid identity according to a security association between the first peer entity and the second peer entity,
wherein a negative validation result is yielded, when it is determined that said identity is not valid.

3. The method according to claim 2, wherein the step of determining is performed on a basis of a security configuration table being maintained at the second peer entity, said security configuration table comprising valid pairs of identities and at least one parameter of said security association.

4. The method according to claim 3, wherein the at least one parameter of said security association comprises the transport address of the first peer entity.

5. The method according to claim 1, wherein the step of validating the identity used by the first peer entity comprises a step of:
detecting whether said identity has changed during an ongoing connection,
wherein a negative validation result is yielded, when it is detected that said identity has changed.

6. The method according to claim 5, further comprising a step of:
storing an identity originally used by the first peer entity in the ongoing connection at the second peer entity.

7. The method according to claim 1, further comprising a step of:
transmitting a response of denial of the requested operation from the second peer entity to the first peer entity, when the step of validating yields a negative validation result.

8. The method according to claim 7, wherein the response indicates a security problem to the first peer entity.

9. The method according to claim 1, wherein an intermediary device is located on the connection in-between the first peer entity and the second peer entity, further comprising a step of:
validating the identity used by the first peer entity at the intermediary device.

10. The method according to claim 9, wherein the step of validating at the intermediary device comprises a step of:
determining whether said identity is a valid identity according to a security association between the first peer entity and the intermediary device,
wherein a negative validation result is yielded, when it is determined that said identity is not valid.

11. The method according to claim 9, wherein the step of validating at the intermediary device comprises a step of:
detecting whether said identity has changed during an ongoing connection,
wherein a negative validation result is yielded, when it is detected that said identity has changed.

12. The method according to claim 9, further comprising a step of:
transmitting a response of denial of the requested operation from the intermediary device to the first peer entity, when the step of validating at the intermediary device yields a negative validation result.

13. The method according to claim 9, further comprising a step of:
forwarding a request from the first peer entity to the second peer entity, when the step of validating at the intermediary device yields a positive validation result.

14. The method according to claim 9, wherein the step of validating comprises validating the identity used by the first peer entity at a proxy node.

15. The method according to claim 9, wherein the step of validating comprises validating the identity used by the first peer entity at a relay agent.

16. The method according to claim 1, wherein the step of validating comprises validating the identity used by an application server at the second peer entity.

17. The method according to claim 1, wherein the step of validating comprises validating the identity used by the first peer entity at a home subscriber server.

18. The method according to claim 1, wherein the method is based on a protocol associated with authorization, authentication and accounting functions.

19. The method according to claim 18, wherein the protocol is a Diameter base protocol.

20. The method according to claim 19, wherein the identity used by the first peer entity is an identity in accordance with a Diameter base protocol.

21. The method according to claim 18, wherein the protocol is a Remote Access Dial-In User Services (RADIUS) protocol.

22. The method according to claim 21, wherein the identity used by the first peer entity is an identity in accordance with a RADIUS protocol.

23. The method according to claim 1, wherein the transport address is based on an Internet protocol.

24. The method according to claim 1, wherein the connection between the first peer entity and the second peer entity comprises an Sh reference point in accordance with Third Generation Partnership Project (3GPP) specifications.

25. A communication device configured for use in a method of providing security of operations on a connection between a first peer entity and the communication device as a second peer entity in a communication system, the peer entities each having an identity and a transport address, wherein the first peer entity requests an operation from the second peer entity using an identity, said communication device comprising:
receiver devices configured to receive a request from the first peer entity;
checker devices configured to check a permission of the first peer entity to be granted the requested operation using said identity by means of a pre-configured permissions list;
first memory devices configured to store the pre-configured permissions list; and
validator devices configured to validate the identity used by the first peer entity, wherein the validator devices are further configured to perform validating prior to the checker devices performing checking of the permission.

26. The communication device according to claim 25, wherein the validator devices comprise:
determinator devices configured to determine whether the identity used by the first peer entity is a valid identity according to a security association between the first peer entity and the second peer entity,
wherein the determinator devices are further configured to yield a negative validation result, when it is determined that said identity is not valid.

27. The communication device according to claim 26, wherein the determinator devices are further configured to perform validating on a basis of a security configuration table being maintained at the second peer entity, said security configuration table comprising valid pairs of identities and at least one parameter of said security association.

28. The communication device according to claim 27, further comprising second memory devices configured to store said security configuration table.

29. The communication device according to claim 27, wherein the at least one parameter of said security association comprises the transport address of the first peer entity.

30. The communication device according to claim 25, wherein the validator devices comprise:
detector devices configured to detect whether the identity used by the first peer entity has changed during an ongoing connection,
wherein the detector devices are further configured to yield a negative validation result, when it is detected that said identity has changed.

31. The communication device according to claim 30, further comprising third memory devices configured to store an identity originally used by the first peer entity in the ongoing connection.

32. The communication device according to claim 25, further comprising:
transmitter devices configured to transmit a response of denial of the requested operation to the first peer entity, when the validator devices yield a negative validation result.

33. The communication device according to claim 32, wherein the response indicates a security problem to the first peer entity.

34. The communication device according to claim 25, wherein the communication device is a home subscriber server.

35. The communication device according to claim 25, wherein the communication device operates on a basis of a protocol associated with authorization, authentication and accounting functions.

36. The communication device according to claim 25, wherein the identity used by the first peer entity is an identity in accordance with a Diameter base protocol.

37. The communication device according to claim 25, wherein the identity used by the first peer entity is an identity in accordance with a Remote Access Dial-In User Services (RADIUS) protocol.

38. The communication device according to claim 25, wherein the transport address is based on an Internet protocol.

39. The communication device according to claim 25, wherein the connection between the first peer entity and the second peer entity comprises an Sh reference point in accordance with Third Generation Partnership Project (3GPP) specifications.

40. An intermediary device configured for use in a method of providing security of operations on a connection between a first peer entity and a second peer entity in a communication system, wherein the intermediary device is located on the connection in-between the first peer entity and the second peer entity, the peer entities each having an identity and a transport address, wherein the first peer entity requests an operation from the second peer entity using an identity, said intermediary device comprising:
receiver devices configured to receive a request from the first peer entity and a response from the second peer entity; and
validator devices configured to validate the identity used by the first peer entity.

41. The intermediary device according to claim 40, wherein the validator devices comprise:
determinator devices configured to determine whether the identity used by the first peer entity is a valid identity according to a security association between the first peer entity and the intermediary device,
wherein the determinator devices are further configured to yield a negative validation result, when it is determined that said identity is not valid.

42. The intermediary device according to claim 41, further comprising first memory devices configured to store a security configuration table.

43. The intermediary device according to claim 40, wherein the validator devices comprise:
detector devices configured to detect whether the identity used by the first peer entity has changed during an ongoing connection,
wherein the detector devices are further configured to yield a negative validation result, when it is detected that said identity has changed.

44. The intermediary device according to claim 43, further comprising second memory devices configured to store an identity originally used by the first peer entity in the ongoing connection.

45. The intermediary device according to claim 40, further comprising:
transmitter devices configured to forward a request from the first peer entity to the second peer entity, when the validator devices of the intermediary device yield a positive validation result.

46. The intermediary device according to claim 40, further comprising:
transmitter devices configured to transmit a response of denial to the first peer entity, when the validator devices of the intermediary device yield a negative validation result.

47. The intermediary device according to claim 40, wherein the intermediary device operates on a basis of a protocol associated with authorization, authentication and accounting functions.

48. The intermediary device according to claim 47, wherein the intermediary device is a Diameter proxy node.

49. The intermediary device according to claim 47, wherein the intermediary device is a Diameter relay agent.

50. A system for providing security of operations on a connection between a first peer entity and a second peer entities in a communication system, the peer entities each having an identity and a transport address, wherein the first peer entity requests an operation from the second peer entity using an identity and the second peer entity checks a permission of the first peer entity to be granted the requested operation using said identity by means of a pre-configured permissions list, said system comprising:
at least one first peer entity comprising
transmitter devices configured to transmit a request for an operation to at least one second peer entity; and
the at least one second peer entity comprising receiver devices configured to receive a request from the at least one first peer entity;
checker devices configured to check the permission of the at least one first peer entity to be granted the requested operation using said identity by means of a pre-configured permissions list;
first memory devices configured to store the pre-configured permissions list; and
validator devices configured to validate the identity used by the at least one first peer entity,
wherein the validator devices are further configured to perform validating prior to the checker devices performing checking of the permission.

51. The system according to claim 50, further comprising at least one intermediary device being located on the connection in-between the first peer entity and the second peer entity, said intermediary device comprising:
receiver devices configured to receive a request from the at least one first peer entity and a response from the at least one second peer entity; and
validator devices configured to validate the identity used by the at least one first peer entity.

52. The system according to claim 50, wherein the at least one first peer entity is an application server.

53. The system according to claim 50, wherein the at least one second peer entity is a home subscriber server.

54. The system according to claim 50, wherein the connection between the first peer entity and the second peer entity comprises an Sh reference point in accordance with Third Generation Partnership Project (3GPP) specifications.

55. A computer program, embodied on a computer readable medium, the computer program controlling a digital-processing device to perform the step of:
validating an identity used by a first peer entity to request an operation from a second peer entity at the second peer entity,
wherein the step of validating is performed prior to a checking of a permission of the first peer entity to be granted the requested operation by means of a pre-configured permissions list by the second peer entity.
